(19) United States
(12) Patent Application Publication
(10) Pub. No.: US 2012/0090556 A1
(43) Pub. Date: Apr. 19, 2012

(54) ANIMAL CHEW TOY

(76) Inventor: JoAnne De Rosa, Milpitas, CA (US)

(21) Appl. No.: 13/276,978

(22) Filed: Oct. 19, 2011

Related U.S. Application Data
(60) Provisional application No. 61/394,627, filed on Oct. 19, 2010.

(51) Int. Cl. A01K 29/00

(52) U.S. Cl. 119/709

(57) ABSTRACT

An animal chew toy with a handle and a hand guard that wraps around knuckles and fingers of a human hand. The handle extends forwardly from or through the hand guard to support a chew toy a distance from the hand guard. The handle also extends rearwardly to be grasped by a hand of the user.

### CROSS-REFERENCE TO RELATED APPLICATION

This application claims priority from provisional patent application Ser. No. 61/394,627, filed Oct. 19, 2010.

### TECHNICAL FIELD

The invention relates to amusement devices and, more particularly, to a toy for a pet.

### BACKGROUND OF THE INVENTION

Certain breeds of dog, particularly larger breeds, such as retrievers and pit bulls, relish the opportunity to play tug-of-war with a person who can pull an object, frequently a rubber chew toy, clasped in the jaws of the dog. Frequently the object is attached to a rope or handle or is otherwise elongated in shape. A problem is that an enthusiastic dog can nip at the hand or arm of a person playing with the dog holding or pulling on the object by means of the rope or handle.

### SUMMARY OF INVENTION

The invention features a self-supporting hand guard, similar to a hand shield found on a sword. The hand guard can be a disk having a diameter that is slightly larger than the width of a hand, i.e. several inches in diameter for protecting the hand. The guard may be dished or curved to wrap around a hand. The chew toy is supported by a handle that projects through the hand guard, such as a folded rope handle. The opposite end of the handle is held by a user's hand. The guard is generally rigid and made of a tough material that can resist force from a user hand or from a dog.

### DESCRIPTION OF THE DRAWING

FIG. 1 shows a perspective view of a hand guard 11 in accordance with the invention.

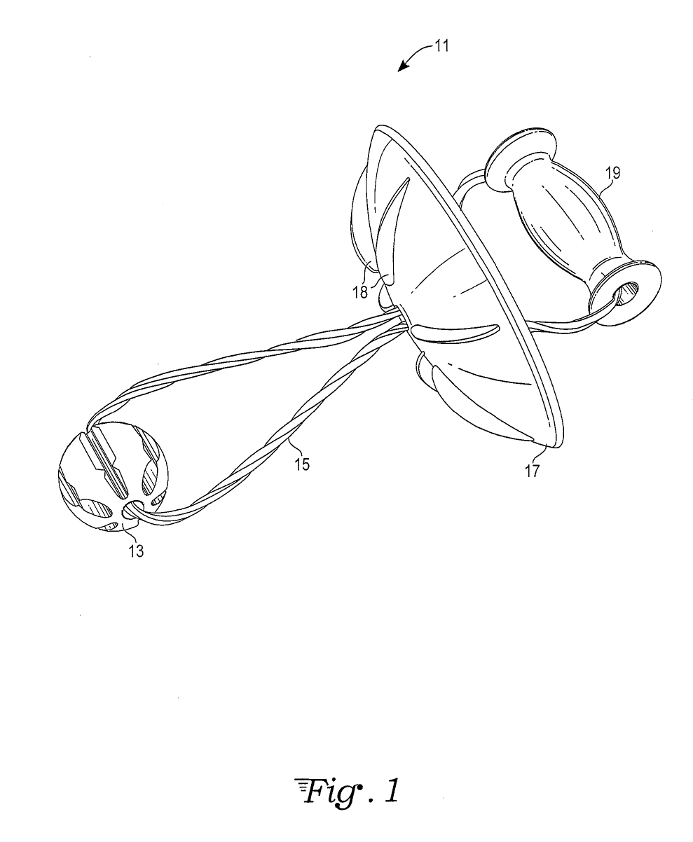

### DETAILED DESCRIPTION

A dog toy or chew object 13 is supported at an end of a doubled, plastic or elastomeric, self-supporting rope that serves as a handle 15 for the toy. It is not necessary to use a plastic rope since any linear, preferably self-supporting handle, such as a rod, will suffice. At one end of the handle the dog toy 13 is mounted, such as by passing the rope through the toy, at a short distance from the hand guard, usually several inches but not more than one foot. The toy or chew object can be any of the chew toys that are known and favored by dogs. The size of the toy and hand guard can correspond to the size of the animal. The toy 13 could be a knot in the rope.

Handle 15 passes through the hand guard 17 before terminating at an optional user grip 19. Ends of a rope may be joined within the user grip or otherwise terminated in the grip. The grip may be cylindrical, as shown, but the shape is not critical so long as the gripping surface allows a user's hand to be mostly behind the hand guard. This requires that the user grip should be located close to the hand guard so that knuckles of a user are protectively shielded behind the hand guard. This allows a user to manipulate the dog toy without risk of a dog bite.

The hand guard 17 can be molded plastic or rubber with circumferential ribs 18 for strength and decorative effect. The ribs can be sized to massage gums or deliver a health product to an animal. The hand guard should be sufficiently tough that encounters with the jaws of a dog will not crack or break the piece. The hand guard could be tough plastic like Nylon or Cordura. When the toy is not in use by a user, a dog may chew on portions of the device not intended for use by the dog. Therefore the hand guard 17, rope and user grip must be particularly tough and resistant to chewing. The hand guard, the handle, and the toy may be one piece or may be separate pieces.

What is claimed is:

1. An animal chew toy apparatus comprising:
a self-supporting hand guard curved to wrap around a portion of a human hand in a protective relation, with a first side proximate to the human hand and a second side opposite the first side; and
an elongated handle passing through the hand guard and adapted to be grasped by the hand of a user on a first side of the hand guard where the handle has a first end and having a second end opposite to the first end where a chew toy is disposed.

2. The apparatus of claim 1 wherein the hand guard is a dished disc.

3. The apparatus of claim 1 wherein the handle is a rope.

4. The apparatus of claim 3 wherein the chew toy is knot in the rope.

5. The apparatus of claim 3 wherein the chew toy is a chewable object through which the rope passes.
